(19) United States
(12) Patent Application Publication
(10) Pub. No.: US 2020/0254742 A1
(43) Pub. Date: Aug. 13, 2020

(54) SURFACE PROTECTION FILM

(71) Applicant: BANDO CHEMICAL INDUSTRIES, LTD., Hyogo (JP)

(72) Inventors: Yutaka KAMADA, Hyogo (JP); Kazumi SAKANO, Hyogo (JP)

(73) Assignee: BANDO CHEMICAL INDUSTRIES, LTD., Hyogo (JP)

(21) Appl. No.: 16/616,972

(22) PCT Filed: May 24, 2018
(86) PCT No.: PCT/JP2018/019983

§ 371 Date: Nov. 26, 2019

(30) Foreign Application Priority Data
May 26, 2017 (JP) 2017-104966

(51) Int. Cl. B32B 27/40; B32B 7/12; C08L 75/06; B32B 27/26; B32B 7/06; B32B 38/00

(52) U.S. Cl. CPC B32B 27/40; B32B 7/12; C08L 75/06; B32B 27/26; B32B 7/06; B32B 2307/714; B32B 2307/748; B32B 2307/412; B32B 2307/732; B32B 2305/72; B32B 2307/584; B32B 38/004

(57) ABSTRACT

The present invention addresses the problem of providing a surface protection film which is resistant to discoloration, expansion, etc. due to the penetration of oils or plasticizers. To solve the problem, a surface protection film having a protective layer made of polyester-based polyurethane on the outermost surface thereof is provided.

### TECHNICAL FIELD

The present invention relates to a surface protection film for protecting a transparent substrate on a surface of a display.

### BACKGROUND ART

In electronic devices including displays such as smartphones, tablet type PCs, portable music players, and the like, in order to protect transparent substrates which are surfaces of the displays, surface protection films are attached thereto in many cases. Surface protection films are required to have light transmittance, non-coloring properties, scratch resistance, weather resistance, self-repairability, and the like. Furthermore, in recent years, these electronic devices have generally been operated using capacitive touch panels, and there are new requirements such as slipperiness, touch panel operability, and the like.

Among such surface protection films, regarding those having excellent operability with a touch pen, the present applicant and others propose, as in Patent Literature 1, a surface protection film obtained by laminating three layers on each other, i.e., a protective layer including a thermosetting polyurethane which is a cured product of a polyether polyol, an aliphatic isocyanate, an alcohol-based curing agent, and a non-amine catalyst, a transparent base film, and an adhesive layer in this order.

Here, since many of the above-mentioned electronic devices include a touch panel and are directly operated using a finger, surface protection films are required to have finger print resistance in which sebum (fingerprints) is prevented from sticking thereto. In addition, various oils derived from cosmetics such as hand cream and sunscreen, foods, and the like with which fingers may be contaminated and various oils from a finger contaminating a surface protection film surface may penetrate into a surface protection film and cause discoloration, expansion, and the like of the surface protection film. Moreover, these electronic devices may have earphone cords wrapped around them and come into contact with various plastic products such as chargers, USB cables, stationery, and cosmetics inside bags and the like, and plasticizers contained therein may penetrate into these electronic devices and cause discoloration, expansion, and the like of the surface protection film.

### REFERENCE LIST

### Patent Literature

Patent Literature 1:PCT International Publication No. WO 2017/094480

### SUMMARY

### Technical Problem

An objective of the present invention is to provide a surface protection film which undergoes hardly any discoloration, expansion, and the like due to penetration of oils or plasticizers.

### Solution to Problem

The configuration of the present invention for accomplishing the above-described objective is as follows.

1. A surface protection film includes: a protective layer made of a polyester-based polyurethane on the outermost surface thereof.

2. In the surface protection film as set forth in 1, at least three layers, i.e., the protective layer, a transparent base film, and an adhesive layer are laminated in this order.

3. In the surface protection film as set forth in 1 or 2, the polyester-based polyurethane is a cured product of a material composition containing a polyester-based polyol, an isocyanate, and an alcohol-based curing agent.

4. In the surface protection film as set forth in any one of 1 to 3, the polyester-based polyurethane is of a succinic acid ester-based polyurethane.

5. In the surface protection film as set forth in 3 or 4, the alcohol-based curing agent includes 70 to 100 parts by weight of trihydric alcohols and 30 to 0 parts by weight of dihydric alcohols.

6. In the surface protection film as set forth in any one of 3 to 5, the alcohol-based curing agent includes a dihydric alcohol having a cyclic structure.

7. In the surface protection film as set forth in any one of 1 to 6, the protective layer has a thickness of 50 μm or more and 300 μm or less.

8. In the surface protection film as set forth in any one of 1 to 7, a haze value is 0.1% or more and 40% or less.

9. A surface protection film laminate includes: a mold release film laminated on the surface of the surface protection film according to any one of 1 to 8 on the protective layer side; and a release film laminated on the other surface thereof.

10. A method for producing a surface protection film having a protective layer made of a polyester-based polyurethane on the outermost surface thereof includes: pouring a material composition containing a polyester-based polyol, an isocyanate, an alcohol-based curing agent, and a catalyst into a gap between first and second gap holding members sent out using a pair of rolls spaced apart from each other; and thermally curing the material composition while the material composition is held between the first and second gap holding members to form the protective layer.

11. In the method for producing a surface protection film as set forth in 10, one of the first and second gap holding members is set as a transparent base film of the surface protection film.

12. In the method for producing a surface protection film as set forth in 10 or 11, the polyester-based polyurethane is of a succinic acid ester-based polyurethane.

13. In the method for producing a surface protection film as set forth in any one of 10 to 12, one of the first and second gap holding members is a film which has not been subjected to a release treatment and the other thereof is a film which has been subjected to a release treatment.

14. In the method for producing a surface protection film as set forth in any one of 10 to 13, the other of the first and second gap holding members is a film having unevenness and the material composition is held on a side of the film having unevenness.

### Advantageous Effects of Invention

In a surface protection film of the present invention, a protective layer is made of a polyester-based polyurethane. The surface protection film of the present invention has excellent oil resistance and plasticizer resistance. In addition, even if various oils and plastic products come into contact with the protective layer, oils or plasticizers do not easily penetrate into the surface protection film and discoloration, expansion, or the like does not easily occur in the surface protection film. The surface protection film of the present invention has excellent light transmittance, non-colorability, scratch resistance, weather resistance, and self-repairability. Furthermore, it is also possible to impart anti-glare properties by forming unevenness in a surface of a protective layer.

The surface protection film of the present invention has optical characteristics in which the surface protection film can be used as a surface protection film even though the protective layer has a thickness of 50 μm or more and 300 μm or less. Furthermore, since a thickness of 50 μm or more and 300 μm or less is used, self-repairability is very good, and even if dents occur, there is recovery over time.

A surface protection film laminate obtained by laminating a mold release film and a release film on a surface protection film of the present invention can prevent a surface protection film from being scratched and becoming dirtied and has excellent handleability.

It is possible to continuously produce the surface protection film using the production method of the present invention. Furthermore, it is possible to produce a protective layer having a thickness of 50 μm or more and 300 μ or less which is difficult to be produced using a wet coating method without optical characteristics deteriorating. In addition, it is possible to easily form unevenness on a surface of a protective layer using a transfer method.

### BRIEF DESCRIPTION OF THE DRAWINGS

FIG. 1 is a diagram illustrating a surface protection film according to an embodiment of the present invention.

FIG. 2 is a diagram illustrating a state in which the surface protection film according to the embodiment of the present invention is adhered to a transparent substrate of a surface of a display.

FIG. 3 is a diagram illustrating a surface protection film laminate.

FIG. 4 is a diagram illustrating a method for producing a protective layer of the surface protection film.

### REFERENCE SIGNS LIST

1 Protective layer

2 Transparent base film

3 Adhesive layer

4 Mold release film

5 Release film

10 Surface protection film

20 Transparent substrate

30 Surface protection film laminate

40 Sheet-like product

40a Material composition

41 Casting machine

41a Head part

42a First gap holding member

42b Second gap holding member

43a Conveyance roll

43b Conveyance roll

44 Conveyance roll

45 Auxiliary roll

46 Heating device

47 Conveyor belt

### DESCRIPTION OF THE EMBODIMENTS

A protection film of the present invention is characterized by having a protective layer made of a polyester-based polyurethane on the outermost surface thereof.

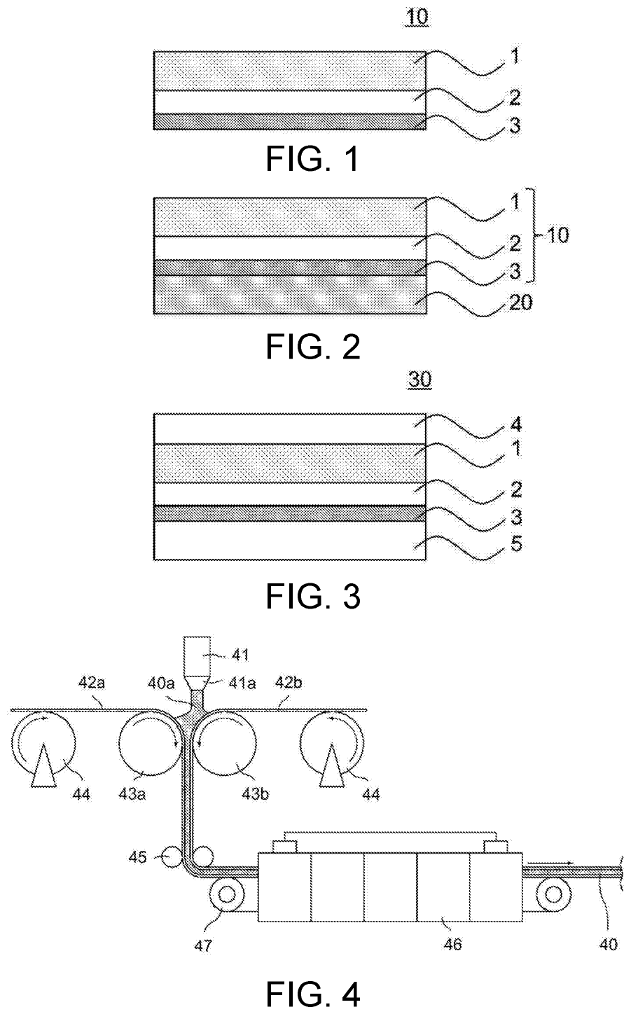

FIGS. 1 and 2 respectively illustrate a surface protection film according to an embodiment of the present invention, and a state in which the surface protection film according to an embodiment is adhered to a transparent substrate located on a surface of the display. In FIGS. 1 and 2, a thickness of each layer does not indicate the actual thickness.

A surface protection film 10 of the embodiment is obtained by laminating three layers, i.e., a protective layer 1 made of a polyester-based polyurethane, a transparent base film 2, and an adhesive layer 3 in this order. Furthermore, the surface protection film 10 of the embodiment is adhered onto a transparent substrate 20 with the adhesive layer 3 therebetween.

In this way, since the surface protection film of the present invention is adhered to a surface of the transparent substrate, the surface protection film prevents the transparent substrate from being scratched, cracking, and becoming contaminated.

“Protective Layer”

A protective layer is made of a polyester-based polyurethane. A polyester-based polyurethane refers to a urethane utilizing a polyester-based polyol as a polyol component. The polyester-based polyurethane used in the present invention is thermally cured as is apparent from the producing method described below in detail.

a. Polyester-Based Polyol

Examples of the polyester-based polyol include a polyester-based polyol obtained through a polymerization reaction between dibasic acids such as succinic acid, adipic acid, phthalic anhydride, isophthalic acid, maleic acid, and fumaric acid and glycols such as ethylene glycol, propylene glycol, 1,4-butanediol, 1,6-hexanediol, and trimethylolpropane.

Among these, succinic acid ester-based polyurethanes using succinic acid as a dibasic acid are particularly desirable because of their excellent oil resistance.

The number average molecular weight of the polyester-based polyol is preferably 200 or more and 10,000 or less, more preferably 500 or more and 5,000 or less, and even more preferably 800 or more and 3,000 or less. When the number average molecular weight is less than 200, a reaction is too fast and the handleability is poor, and a molded body loses its flexibility and thus becomes brittle in some cases. On the other hand, when the number average molecular weight is more than 10,000, the viscosity is too high, the handleability is poor, and a molded body may become crystallized and thus become cloudy in some cases. In the present invention, the number average molecular weight refers to a molecular weight calculated from a hydroxyl value of a polyol measured in accordance with JIS K1557. Here, even if the number average molecular weight is outside of the above-mentioned numerical value range, the number average molecular weight is not excluded unless the number average molecular weight deviates from the gist of the present invention.

b. Isocyanate

Any isocyanate can be used without particular limitation as long as it has two or more isocyanate groups in a molecule. For example, tolylene diisocyanate, tolidine diisocyanate, diphenylmethane diisocyanate, polymethylene polyphenyl polyisocyanate, carbodiimidized diphenylmethane polyisocyanate, crude diphenylmethane diisocyanate, xylylene diisocyanate, 1,5-naphthalene diisocyanate, tetramethylxylene diisocyanate, isophorone diisocyanate, hydrogenated diphenylmethane diisocyanate, hydrogenated xylylene diisocyanate, hexamethylene diisocyanate, dimer acid diisocyanate, norbornene diisocyanate, and the like can be used. Two or more of these may be used in combination.

It is desirable that the polyester-based polyurethane which forms the protective layer of the present invention use an aliphatic isocyanate having no aromatic ring as an isocyanate component. A polyurethane obtained from an aliphatic isocyanate does not easily yellow and can prevent the polyurethane from discoloring due to light or heat from a light source, sunlight, and the like, thereby reducing transparency.

c. Alcohol-Based Curing Agent

The polyester-based polyurethane which forms the protective layer of the present invention uses an alcohol-based curing agent as a curing agent. An alcohol-based curing agent has less adverse effects on the human body and the environment than an amine-based curing agent.

Any alcohol-based curing agent can be used without particular limitation as long as it has two or more hydroxy groups in a molecule. For example, dihydric alcohols such as ethylene glycol, 1,3-propanediol, 2-methyl-1,3-propanediol, 1,3-butanediol, 1,4-butanediol, 1,5-pentanediol, neopentyl glycol (2,2-dimethyl-1,3-propanediol), 1,6-hexanediol, polyethylene glycol, polypropylene glycol, polybutylene glycol, cyclohexanedimethanol, and hydrogenated bisphenol A, trihydric alcohols such as glycerin, trimethylolpropane, butanetriol, pentanetriol, hexanetriol, cyclopentanetriol, and cyclohexanetriol, and trihydric or higher alcohols such as pentaerythritol, dipentaerythritol, and tetramethylolpropane may be exemplified. Among these, when a dihydric alcohol is used as a main component, since a molded body then may become crystallized and cloudy in some cases and a polyurethane obtained from a trihydric alcohol has excellent oil resistance, it is desirable to use a trihydric alcohol as a main component. To be specific, the alcohol-based curing agent preferably includes 70 to 100 parts by weight of trihydric alcohols and 30 to 0 parts by weight of dihydric alcohols, more preferably 90 to 100 parts by weight of trihydric alcohols and 10 to 0 parts by weight of dihydric alcohols, and most preferably 100 parts by weight of trihydric alcohols. As the trihydric alcohol, trimethylolpropane is desirable in view of the handleability and the mechanical properties. As the dihydric alcohol, a dihydric alcohol having a cyclic structure such as cyclohexanedimethanol and hydrogenated bisphenol A are desirable in view of preventing cloudiness.

d. Catalyst

It is desirable that the polyester-based polyurethane which forms the protective layer of the present invention be thermally cured in the presence of a non-amine catalyst. Using a non-amine catalyst, it is possible to obtain a polyurethane having excellent non-coloring property, transparency, and weather resistance. On the other hand, in a polyurethane obtained through thermal curing using an amine-based catalyst, outgoing light becomes yellow and an outer form becomes colored over time in some cases.

Examples of the non-amine catalyst include organotin compounds such as di-n-butyltin dilaurate, dimethyltin dilaurate, dibutyltin oxide, and octane tin, organic titanium compounds, organic zirconium compounds, carboxylic acid tin salts, and carboxylic acid bismuth salts, and the like. Among these, organotin compounds are desirable because they allow a reaction rate to be adjusted easily.

It is desirable that 0.0005 wt % or more and 3.0 wt % or less of the non-amine catalyst be added with respect to the total amount of a to c described above. When the non-amine catalyst is less than 0.0005 wt %, a reaction rate may not be sufficiently rapid and thus a molded body may not be able to be obtained efficiently. When the non-amine catalyst is more than 3.0 wt %, a reaction rate is too fast and thus problems in which it is not possible to obtain a molded body having a uniform thickness, heat resistance and weather resistance of the molded body are reduced, light transmittance decreases, and the molded body is colored occur in some cases. Here, even if the amount of non-amine catalyst to be added is outside of the above-mentioned numerical value range, the amount is not excluded unless the amount deviates from the gist of the present invention.

The polyester-based polyurethane which forms the protective layer can contain various additives such as a colorant, a light stabilizer, a heat stabilizer, an antioxidant, an antifungal agent, a flame retardant, and a lubricant as necessary as long as the required characteristics are not impaired.

In the surface protection film of an embodiment, the protective layer is the molded body made of the polyester-based polyurethane obtained by curing a polyester-based polyol, an isocyanate, and an alcohol-based curing agent in the presence of the catalyst. The molding method may be any one of a one-shot method, a prepolymer method, and a pseudo prepolymer method. Furthermore, the protective layer can contain any additive.

In the one-shot method, it is possible to prepare a molded body made of a polyester-based polyurethane by inputting a polyester-based polyol, an isocyanate, an alcohol-based curing agent, any additive, and a catalyst together and curing them.

In the prepolymer method, it is possible to prepare a molded body made of a polyester-based polyurethane by causing a polyester-based polyol and a stoichiometric excess of an isocyanate to react to prepare a prepolymer having an isocyanate group on a terminal in advance, incorporating a predetermined amount of an alcohol-based curing agent, any additives, and a catalyst into the prepared prepolymer, and curing the prepolymer.

In the pseudo prepolymer method, it is possible to prepare a molded body made of a polyester-based polyurethane by mixing a part of a polyester-based polyol with an alcohol-based curing agent in advance, preparing a prepolymer using the remaining polyester-based polyol and an isocyanate, mixing a mixture of a polyester-based polyol, an alcohol-based curing agent, any additive, and a catalyst which have been mixed in advance with the prepared prepolymer, and curing the mixture.

In the present invention, a ratio (—OH/—NCO: hereinafter referred to as an “a ratio”) between the number of moles of hydroxyl groups (—OH) contained in an alcohol-based curing agent and the number of moles of isocyanate groups (—NCO) of an isocyanate or a prepolymer in a material composition in which a polyester-based polyurethane is not thermally cured is preferably 0.8 or more and 1.5 or less. When the a ratio is less than 0.8, mechanical properties are unstable. In addition, when the a ratio is more than 1.5, surface tackiness increases and operability deteriorates. Furthermore, the a ratio is more preferably 1.05 or more and 1.3 or less because then the polyurethane which constitutes the protective layer deforms appropriately and scratch resistance is improved.

Also, it is desirable that a polyurethane do not contain an acrylic skeleton (an acrylic skeleton or a methacrylic skeleton). That is to say, it is desirable that the polyester-based polyurethane which forms the protective layer of the present invention do not contain an acrylic-modified polyurethane. A polyester-based polyurethane having an acrylic skeleton impairs the flexibility of a polyurethane and reduces wear resistance and a mechanical strength such as tear strength in some cases. In addition, outgoing light is colored due to the residue of a catalyst used to introduce the acrylic skeleton or an acrylic skeleton in some cases.

A thickness of the protective layer is preferably 50 μm or more and 300 μm or less, more preferably 100 μm or more and 200 μm or less. When the protective layer has a thickness of 50 μm or more and 300 μm or less, it is possible to obtain a surface protection film having excellent operability and self-repairability. When the thickness of the protective layer is less than 50 μm, self-repairability is reduced; and when the thickness of the protective layer is more than 300 μm, light transmittance, non-colorability, operability, and self-repairability are reduced and thus it is difficult to perform molding to have a uniform thickness. When the thickness of the protective layer is 50 μm or more and 300 μm or less, the performance required for the surface protection film is exhibited in a well-balanced manner and production is easy.

A haze value of the surface protection film is preferably 0.1% or more and 40% or less. Furthermore, the total light transmittance is preferably 90% or more. When the haze value is more than 40% or the total light transmittance is less than 90%, the visibility of the display is reduced. When the haze value of the surface protection film is 0.1% or more and less than 3%, it is possible to obtain excellent transparency and a clear outer form. When the haze value of the surface protection film is 3% or more and 40% or less, it is possible to impart anti-glare properties to the surface protection film. Furthermore, in the surface protection film having anti-glare properties, scratches present in the surface of the protective layer are not easily distinguished. In order to make the surface protection film have a haze value of 3% or more and 40% or less, unevenness may be formed in the surface of the protective layer. An unevenness shape of the surface of the protective layer is not particularly limited as long as it has the above-mentioned haze value and total light transmittance and may be appropriately adjusted in accordance with a refractive index, light absorption, and the like of a material to be used, but an average length (RSm) of a roughness curve element is usually about 10 μm or more and 80 μm or less. Furthermore, an arithmetic average roughness Ra is about 0.01 μm or more and 0.3 μm or less and a maximum height Rz is about 0.1 μm or more and 2.0 μm or less.

“Transparent Base Film”

A transparent base film holds a protective layer. A material constituting the transparent base film can be used without particular limitation as long as it has excellent transparency, flexibility, and mechanical strength and polyethylene terephthalate (PET), polyethylene naphthalate (PEN), polycarbonate (PC), cyclic olefin resin (COP), polyimide (PI), and the like can be suitably used as the material.

A thickness of the transparent base film is preferably 50 μm or more and 500 μm or less. In the surface protection film of the present invention, a thermal expansion coefficient of a polyester-based polyurethane which forms the protective layer is usually larger than a thermal expansion coefficient of a material constituting the transparent base film. Thus, when the thickness of the transparent base film is less than 50 μm, the transparent base film is not sufficiently resistant to the shrinkage of the protective layer at a low temperature and the surface protection film peels off from the transparent substrate in some cases. When the thickness of the transparent base film is more than 500 μm, the surface protection film is bulky and the production costs thereof increases. Furthermore, the operability when the transparent base film is adhered to a surface of a touch panel type display is reduced. Description will be provided in detail in the “method for producing the protective layer” which will be described later, but the protective layer can be formed directly above the transparent base film. In this producing method, in order to prevent deformation during heating when the material composition is thermally cured to form the protective layer, it is desirable that the transparent base film be thicker. Here, even if the thickness is outside of the above-mentioned numerical value range, the thickness is not excluded unless the thickness deviates from the gist of the present invention.

“Adhesive Layer”

An adhesive layer is used to adhere the surface protection film of the present invention onto the transparent substrate of the surface of the display. A type of adhesive is not particularly limited and an adhesive made of an acrylic-based resin, an epoxy-based resin, a urethane-based resin, a silicone-based resin, or the like can be used. Among these, an adhesive made of an acrylic-based resin can be adhered to even a surface substrate which has been subjected to a surface treatment such as an antifouling treatment and a low reflection treatment. Furthermore, an adhesive made of a silicone-based resin has excellent wetting property, hardly causes bubbles when adhered to the transparent substrate, has good re-peeling properties, and hardly any thereof remains at the time of peeling off. A thickness of the adhesive layer is usually in the range of 5μm or more and 60 μm or less, but can be adjusted appropriately in accordance with the required specifications.

In order to protect a surface protection film of an embodiment until it is adhered to the transparent substrate of the surface of the display, it is possible to make the surface protection film laminate by adhering a mold release film to the surface of the surface protection film on the protective layer side and a release film to the other surface thereof. FIG. 3 illustrates a surface protection film laminate 30 having a mold release film 4 and a release film 5 adhered thereto. In FIG. 3, the thickness of each layer does not mean the actual thickness.

The mold release film is for the purpose of preventing the protective layer from becoming dirty and adhering of dust and it is desirable to use a film having a surface on the side to be adhered to the protective layer which has been subjected to a release treatment. When the mold release film which has been subjected to a release treatment is released from the protective layer, a release agent moves to the surface of the protective layer and can impart slipperiness to the surface of the protective layer immediately after the mold release film is released, and thus it is possible to perform a touch operation without causing uncomfortable feeling. Furthermore, description will be provided in detail in the “method for producing the protective layer” which will be described later, but the protective layer can be formed directly above the mold release film. At this time, in order to prevent deformation during heating when the material composition is thermally cured to form the protective layer, a thickness of the mold release film is preferably 50 μm or more and 300 μm or less and more preferably thicker.

It is desirable that the release film be adhered to the adhesive layer to prevent dirt, dust adhesion, a decrease in adhesive strength, and the like. The release film is not particularly limited and it is possible to appropriately use a film having a surface on a side to be adhered to the adhesive layer which has been subjected to a release treatment.

“Method for Producing Protective Layer”

A protective layer can be produced using a polyester-based polyurethane obtained by pouring a uncured material composition which contains at least a polyester-based polyol, an isocyanate (or a urethane prepolymer made of any of these), an alcohol-based curing agent, any additive, and a catalyst into a gap between first and second gap holding members sent out using pair of rolls spaced apart from each other, introducing a material composition into a heating device while the material composition is being held between the two gap holding members, and thermally curing the material composition.

FIG. 4 illustrates a schematic diagram of the method for producing the protective layer. The method for producing the protective layer will be described below using FIG. 4.

A material composition 40a is poured into a gap between first and second gap holding members 42a and 42b sent out using a pair of conveyance rolls 43a and 43b spaced apart from each other using a casting machine 41. The first and second gap holding members 42a and 42b are guided into a heating device 46 while the material composition 40a is being held therebetween. A sheet-like product 40 made of a polyester-based polyurethane is produced by thermally curing the material composition 40a while the material composition 40a is being held between the first and second gap holding members 42a and 42b.

In FIG. 4, conveyance rolls configured to send out the first and second gap holding members 42a and 42b are denoted with 44, auxiliary rolls are denoted with 45, and a conveyor belt configured to convey the first and second gap holding members 42a and 42b having the material composition 40a held therebetween in the heating device 46 is denoted with 47.

The first and second gap holding members 42a and 42b can be used without particular limitation as long as they are materials which do not thermally deform when the material composition is thermally cured. For example, it is possible to use a long film made of a polymer material such as polyethylene terephthalate (PET), polyethylene naphthalate (PEN), polycarbonate (PC), cyclic olefin resin (COP), and polyimide (PI). Although a long film made of a polymer material is used for the gap holding members in the schematic diagram illustrated in FIG. 4, it is also possible to use an endless belt made of such polymer materials or a metal material such as aluminum.

Since the first and second gap holding members 42a and 42b are pulled and conveyed with the same tension while holding the material composition 40a therebetween, the gap can be maintained to have a constant size. Since the material composition 40a is placed between the first and second gap holding members 42a and 42b and cured while a constant thickness is being maintained, the sheet-like product 40 having an excellent thickness precision is obtained. Using this producing method, it is possible to continuously form the sheet-like product 40 having a thickness of 30 μm or more which is difficult to be applied and having practical optical characteristics as the surface protection film for the display.

It is desirable that a position of a head part 41a in the casting machine 41 be unevenly distributed toward one side of the conveyance rolls from a central portion of the conveyance rolls 43a and 43b (a central portion of the gap formed by the first and second gap holding members 42a and 42b) and it is desirable that an uneven distribution distance be equal to or less than a radius of the conveyance rolls. That is to say, it is desirable that a portion directly below the head part 41a in the casting machine 41 be located between a central portion of the pair of conveyance rolls 43a and 43b and a central axis of one of the conveyance rolls. Furthermore, a shortest distance between a distal end portion of the head part 41a and surfaces of the conveyance rolls is preferably 5 cm or less. By arranging the head part 41a in this way, a thickness accuracy of the sheet-like product 40 is further improved, air bubbles are not easily mixed into the uncured material composition 40a poured into the gap between the first and second gap holding members 42a and 42b and the incorporated bubbles are easily removed.

The conveyance rolls 43a and 43b may simply have only a conveyance function, but it is desirable that the conveyance rolls 43a and 43b be heating rolls. When the conveyance rolls are heating rolls, it is possible to perform a curing reaction immediately after the material composition 40a is held in the gap between the first and second gap holding members 42a and 42b, to maintain a further uniform thickness until the material composition 40a is introduced into the heating device 46, and to form the sheet-like product 40 having a better thickness precision. A conveyance surface temperature at the time of heating the conveyance rolls is set to 10 to 60° C. When the conveyance surface temperature is less than 10° C., a viscosity of the material composition increases and thus air bubbles are not easily removed and a rate of a curing reaction decreases and thus a thickness accuracy of the sheet-like product 40 decreases. When the conveyance surface temperature exceeds 60° C., the material composition 40a is cured on the conveyance rolls or air bubbles are input into the sheet-like product 40 in some cases. The heating device 46 is a heating furnace which includes a heater and any heating device may be adopted as the heating device 46 as long as it can increase a temperature inside the furnace to a curing temperature of the material composition 40a. Furthermore, heating conditions (curing conditions) in the heating device 46 are not particularly limited, any heating conditions (curing conditions) may be adopted as the heating conditions (curing conditions) as long as they are appropriately set in accordance with a composition of the material composition 40a, and for example, the heating (curing) may be performed under conditions of 40° C. to 160° C. for 1 minute to 180 minutes.

A long laminate formed of the first gap holding member 42a, the sheet-like

product 40 made of a polyurethane, and the second gap holding member 42b is carried out from the heating device 46. Moreover, the sheet-like product 40 serves as the protective layer of the surface protection film of the present invention.

“Method for Producing Surface Protection Film Laminate”

In the above-mentioned producing method, it is possible to make one of the first gap holding member 42a and the second gap holding member 42b serve as the transparent base film 2 in the surface protection film 10 of an embodiment. Furthermore, it is possible to make the other of the first gap holding member 42a and the second gap holding member 42b serve as the mold release film 4. A case in which the first gap holding member 42a serves as the transparent base film 2 and the second gap holding member 42b serves as the mold release film 4 will be described below as an example.

Using the above-mentioned producing method, the long laminate formed of the first gap holding member 42a serving as the transparent base film 2, the sheet-like product 40 made of a polyurethane serving as the protective layer 1, and the second gap holding member 42b serving as the mold release film 4 is taken out. At this time, it is desirable that a film which has not been subjected to a release treatment be used as the first gap holding member 42a serving as the transparent base film and a film which has been subjected to a release treatment be used as the second gap holding member 42b serving as the mold release film.

Since the adhesive layer is formed on a surface of the long laminate on the first gap holding member 42a carried out from the heating device using coating or the like and the release film is adhered onto the adhesive layer, it is possible to obtain the long surface protection film laminate 30. Furthermore, it is also possible to use a laminate obtained by laminating a transparent base film/an adhesive layer/a release film in this order as the first gap holding member 42a. In addition, since a film having unevenness is used as the second gap holding member 42b and the material composition 40a is held on a side thereof having unevenness, it is possible to transfer unevenness to the outermost surface of the sheet-like product 40 serving as the protective layer.

Using this producing method, it is possible to continuously produce the surface protection film laminate 30 using so-called roll to roll processing. The produced surface protection film laminate 30 has both surfaces having a mold release film and a release film, respectively, and it is possible to prevent the surface protection film from being scratched, contaminated, or the like and has excellent handleability.

The surface protection film laminate may be rolled and shipped in a roll shape or may be shipped after being cut into a sheet shape. Furthermore, it is also possible to ship a long laminate formed of the first gap holding member 42a, the sheet-like product 40 made of a polyurethane, and the second gap holding member 42b or a product obtained by cutting this laminate, after which to form an adhesive layer on the laminate through coating in a display factory or the like, and adhere the laminate to the transparent substrate of the display.

The above-described producing method is an example, and for example, it is also possible to produce a laminate by adhering the protective layer produced through the “method for producing the protective layer” to a sheet-like or roll-like transparent base film.

### EXAMPLES

While the present invention will be described below in more detail using examples, the present invention is not limited to these examples.

### Example 1

A material composition (an a ratio: 0.95) was prepared by adding, stirring, and mixing 100 g of succinic ester-based polyol (manufactured by Tosoh Corporation, product name: ON-300), 10 g of trimethylolpropane, 32.6 g of xylylene diisocyanate (manufactured by Mitsui Chemicals, Inc., product name: TAKENATE T500), and 50 ppm of an organotin compound.

A surface protection film laminate having a protective layer made of a succinic polyester-based polyurethane having a thickness of 100 μm was produced using a laminate obtained by laminating a PET film (corresponding to a release film) having a thickness of 75 μm which has been subjected to a silicone treatment/a silicone-based adhesive layer having a thickness of 50 μm/a PET film (corresponding to a transparent base film) having a thickness of 100 μm in this order as a first gap holding member and a PET film (corresponding to a mold release film) having a thickness of 125 μm which has been subjected to a silicone treatment as a second gap holding member through the above-described molding method.

### Example 2

A surface protection film laminate was obtained in the same manner as in Example 1 except that 15 g of trimethylolpropane and 43.7 g of xylylene diisocyanate were used.

### Example 3

A surface protection film laminate was obtained in the same manner as in Example 1 except that 5 g of cyclohexanedimethanol and 17.4 g of xylylene diisocyanate were used instead of trimethylolpropane.

### Example 4

A surface protection film laminate was obtained in the same manner as in Example 3 except that 10 g of cyclohexanedimethanol and 24.3 g of xylylene diisocyanate were used.

### Comparative Example 1

A surface protection film laminate was obtained in the same manner as in Example 1 except that an alcohol-based curing agent having a weight ratio of 1,4-butanediol/trimethylolpropane=97/3 was used.

### Comparative Example 2

A surface protection film laminate was obtained in the same manner as in Example 1 except that succinic ester-based polyol was replaced with olefin-based polyol (manufactured by Idemitsu Kosan Co., Ltd., product name: EPOL) and 31.5 g of xylylene diisocyanate was used.

### Comparative Example 3

A surface protection film laminate was obtained in the same manner as in Example 1 except that succinic ester-based polyol was replaced with polycarbonate-based polyol (manufactured by UBE INDUSTRIES, LTD, product name: ETERNACOLL UM90) and 44.0 g of xylylene diisocyanate was used.

### Comparative Example 4

A surface protection film laminate was obtained in the same manner as in Comparative Example 3 except that trimethylolpropane was replaced with cyclohexanedimethanol and 35.7 g of xylylene diisocyanate was used.

The surface protection film laminates produced in Examples 1 to 4 and Comparative Examples 1 to 4 described above were evaluated as follows. The results are shown in Tables 1 and 2.

### International Rubber Hardness Degree (IRHD)

A 1 cm square sample was cut from a created surface protection film laminate, a mold release film and a release film were released, after which hardness thereof on a protective layer side was measured using an IRHD rubber hardness tester (manufactured by HILDE).

### Haze and Total Light Transmittance

A 5 cm square sample was cut from a created surface protection film laminate, a mold release film and a release film were released, the sample was set so that a surface thereof on a protective layer side was present on a light source side, and measurement was performed using a haze meter (manufactured by NIPPON DENSHOKU INDUSTRIES Co., LTD, device name: NDH7000 (CU-II specification)).

Oil Resistance

A mold release film was released from a created surface protection film and one drop of oil shown in Tables 1 and 2 which will be described later was dropped on a protective layer. After the dripping and leaving at room temperature for 7 days, the oil was completely wiped off, the dripping portion was confirmed visually, and evaluation was performed in accordance with the following criteria.

1: No trace of droplet

2: Slightly visible traces of droplets

3: Clearly visible droplet marks

4: Slightly swollen

5: Swelling significantly

### Plasticizer Resistance

A mold release film is released from a created surface protection film and one drop of a plasticizer shown in Tables 1 and 2 below was dropped on a protective layer. After the dripping and leaving at room temperature for 14 hours, the plasticizer was completely wiped off, the dripping portion was confirmed visually, and evaluation was performed in accordance with the following criteria.

1: No trace of droplet

2: Slightly visible traces of droplets

3: Clearly visible droplet marks

4: Slightly swollen

5: Swelling significantly

TABLE 1

| | | Example 1 | Example 2 | Example 3 | Example 4 |
|---|---|---|---|---|---|
| Hardness (IRHD) | | 87 | 93 | 78 | 80 |
| Haze (%) | | 0.93 | 0.79 | 0.78 | 0.97 |
| Total light transmittance (%) | | 92 | 92 | 91 | 92 |
| Oil | Oleic acid | 1 | 1 | 2 | 2 |
| resistance | Hand cream | 1 | 1 | 2 | 2 |
| | Sunscreen oil | 1 | 1 | 2 | 2 |
| Plasticizer | Bis(2-ethylhexyl)phthalate | 1 | 1 | 1 | 1 |
| resistance | Bis(2-ethylhexyl) adipate | 1 | 1 | 1 | 1 |
| | Diisononyl phthalate | 1 | 1 | 1 | 1 |
| | Polyether ester plasticizer | 1 | 1 | 2 | 2 |
| | (Product name: Adeka | | | | |
| | Sizer RS735) | | | | |

TABLE 2

| | | Comparative | Comparative | Comparative | Comparative |
|---|---|---|---|---|---|
| | | Example 1 | Example 2 | Example 3 | Example 4 |
| Hardness (IRHD) | | 88 | 87 | 99 | 99 |
| Haze (%) | | 99.6 | 99.5 | 0.8 | 0.9 |
| Total light transmittance (%) | | 78.3 | 79.5 | 92 | 91 |
| Oil | Oleic acid | 1 | 5 | 3 | 3 |
| resistance | Hand cream | 1 | 5 | 2 | 2 |
| | Sunscreen oil | 1 | 5 | 3 | 3 |
| Plasticizer | Bis(2-ethylhexyl)phthalate | 1 | 5 | 1 | 1 |
| resistance | Bis(2-ethylhexyl) adipate | 1 | 5 | 1 | 1 |
| | Diisononyl phthalate | 1 | 5 | 1 | 1 |
| | Polyether ester plasticizer | 1 | 5 | 1 | 1 |
| | (Product name: Adeka | | | | |
| | Sizer RS735) | | | | |

The surface protection films produced in Examples 1 to 4 had excellent oil resistance and plasticizer resistance. Particularly, the surface protection films produced in Examples 1 and 2 using trimethylolpropane which is trihydric alcohol as an alcohol-based curing agent showed excellent oil resistance and plasticizer resistance.

On the other hand, the surface protection film produced in Comparative Example 1 had excellent oil resistance and plasticizer resistance, but was cloudy. The film produced in Comparative Example 2 was cloudy in the first place, and had inferior oil resistance and plasticizer resistance. The films produced in Comparative Examples 3 and 4 had excellent plasticizer resistance, but had inferior oil resistance.

1. A surface protection film, comprising:
a protective layer made of a polyester-based polyurethane on an outeiixiost surface thereof.

2. The surface protection film according to claim 1, wherein at least three layers of the protective layer, a transparent base film, and an adhesive layer are laminated in this order.

3. The surface protection film according to claim 1, wherein the polyester-based polyurethane is a cured product of a material composition containing a polyester-based polyol, an isocyanate, and an alcohol-based curing agent.

4. The surface protection film according to claim 1, wherein the polyester-based polyurethane is a succinic acid ester-based polyurethane.

5. The surface protection film according to claim 3, wherein the alcohol-based curing agent comprises 70 to 100 parts by weight of trihydric alcohols and 30 to 0 parts by weight of dihydric alcohols.

6. The surface protection film according to claim 3, wherein the alcohol-based curing agent comprises a dihydric alcohol having a cyclic structure.

7. The surface protection film according to claim 1, wherein the protective layer has a thickness of 50 μm or more and 300 μm or less.

8. The surface protection film according to claim 1, wherein a haze value is 0.1% or more and 40% or less.

9. A surface protection film laminate, comprising:
a mold release film laminated on a surface of the surface protection film according to claim 1 on the protective layer side; and
a release film laminated on the other surface thereof.

10. A method for producing a surface protection film having a protective layer made of a polyester-based polyurethane on an outermost surface thereof, comprising:
pouring a material composition containing a polyester-based polyol, an isocyanate, an alcohol-based curing agent, and a catalyst into a gap between first and second gap holding members sent out using a pair of rolls spaced apart from each other; and
thermally curing the material composition while the material composition is held between the first and second gap holding members to form the protective layer.

11. The method for producing a surface protection film according to claim 10, wherein one of the first and second gap holding members is set as a transparent base film of the surface protection film.

12. The method for producing a surface protection film according to claim 10, wherein the polyester-based polyurethane is a succinic acid ester-based polyurethane.

13. The method for producing a surface protection film according to claim 10, wherein one of the first and second gap holding members is a film which has not been subjected to a release treatment and the other thereof is a film which has been subjected to a release treatment.

14. The method for producing a surface protection film according to claim 11, wherein the other of the first and second gap holding members is a film having unevenness and the material composition is held on a side of the film having unevenness.

15. The method for producing a surface protection film according to claim 11, wherein one of the first and second gap holding members is a film which has not been subjected to a release treatment and the other thereof is a film which has been subjected to a release treatment.

16. The method for producing a surface protection film according to claim 13, wherein the other of the first and second gap holding members is a film having unevenness and the material composition is held on a side of the film having unevenness.

17. The surface protection film according to claim 2, wherein the polyester-based polyurethane is a cured product of a material composition containing a polyester-based polyol, an isocyanate, and an alcohol-based curing agent.

18. The surface protection film according to claim 2, wherein the polyester-based polyurethane is a succinic acid ester-based polyurethane.

19. The surface protection film according to claim 5, wherein the alcohol-based curing agent comprises a dihydric alcohol having a cyclic structure.

20. The surface protection film according to claim 2, wherein the protective layer has a thickness of 50 μm or more and 300 μm or less.
